(19) United States
(12) Patent Application Publication
(10) Pub. No.: US 2016/0275854 A1
(43) Pub. Date: Sep. 22, 2016

(54) DISPLAY DEVICE, PIXEL DRIVING CIRCUIT AND DRIVING METHOD FOR THE SAME

(71) Applicant: EverDisplay Optronics (Shanghai) Limited, SHANGHAI CITY (CN)

(72) Inventors: Jiangang WANG, SHANGHAI CITY (CN); Xingyu ZHOU, SHANGHAI CITY (CN)

(21) Appl. No.: 14/989,209

(22) Filed: Jan. 6, 2016

(30) Foreign Application Priority Data
Mar. 18, 2015 (CN) 201510119784.4

(51) Int. Cl. G09G 3/32

(52) U.S. Cl. CPC G09G 3/325; G09G 3/3258; G09G 3/3266; G09G 2320/0233; G09G 2310/0272; G09G 2300/0819; G09G 2300/0842

(57) ABSTRACT

A pixel driving circuit includes an OLED, a first switching element to a fourth switching element, a storage capacitor and a driving transistor, wherein the first switching element to the third switching element are respectively configured to apply a driving voltage and a threshold voltage of the driving transistor to a first terminal of the storage capacitor, apply the driving voltage to a second terminal of the storage capacitor, and apply a data signal to the second terminal of the storage capacitor, the driving transistor has a gate connected to the second terminal of the storage capacitor, a source connected to the driving voltage, and a drain connected to the fourth switching element, and the fourth switching element is configured to apply a driving current output from the drain of the driving transistor to the OLED to make it to emit light. A display and a method are also provided.

### CROSS REFERENCE TO RELATED APPLICATIONS

The present application is based upon and claims priority to Chinese Patent Application No. 201510119784.4, filed on Mar. 18, 2015, the entire contents of which are incorporated herein by reference.

### TECHNICAL FIELD

The present disclosure relates to the field of display technology, and particularly to a pixel driving circuit, a driving method for the pixel driving circuit and a display device including the pixel driving circuit.

### BACKGROUND

Compared with a liquid crystal display panel in conventional art, an OLED (Organic Light Emitting Diode) display panel has advantages of faster response, better color purity and brightness, higher contrast and broader perspective, etc. Consequently, OLED display panels attract developers of display technology more and more.

A pixel unit of an OLED display panel generally includes an organic light emitting diode and a pixel-unit driving circuit for driving the organic light emitting diode. FIG. 1 is a schematic diagram of a 3T1C pixel-unit driving circuit in a related art, which includes a third switching transistor T3, a fourth switching transistor T4, a driving transistor DTFT and a storage capacitor Cst. Wherein the third switching transistor T3 is controlled by a first scan signal Sn output by a scan line (Scan Line), for controlling a data signal Data of a data line (Data Line) to be written. The driving transistor DTFT is configured to output a driving current. The fourth switching transistor T4 is configured to, under a control of a light-emitting control signal En, transmit the driving current to the organic light emitting diode OLED to make it to emit light. The storage capacitor Cst is configured to provide a sustain voltage to drive the gate of the driving transistor DTFT.

The organic light emitting diode OLED may emit light, when it is driven through a driving current generated by the driving transistor DTFT operating in a saturation state, and the driving current I_{OLED} may be expressed as:

$${I}_{OLED} = \frac{1}{2} {μ}_{n} \cdot {C}_{OX} \cdot \frac{W}{L} \cdot {( ELVDD - Vdata - Vth )}^{2} .$$

Wherein μₙ·C_{OX}·W/L is a constant related to manufacturing process and design of the driving. For example, μₙ is a carrier mobility, C_{OX} is a capacitance of a gate oxide layer, W/L is a ratio of width to length of a transistor, Vdata is a voltage of the data signal Data, ELVDD is a driving voltage of the driving transistor DTFT shared by all the pixel units, and Vth is a threshold voltage of the driving transistor DTFT.

However, due to technical limitations, the threshold voltages Vth have poor uniformity, and may shift in use. It may be seen from the above equation that, if threshold voltages Vth are different among the pixel driving units, the driving currents may be different, which may result in an uneven brightness. If a threshold voltage Vth of a driving transistor shifts over time, the current of the same data will vary over time, which may affect display effect.

### SUMMARY

An object of the present disclosure is to provide a pixel driving circuit, a method for driving the pixel driving circuit and a display device including the pixel driving circuit, so as to overcome, at least to a certain degree, one or more problems caused by limits and defects of the related art.

Other features and advantages of the present disclosure will become apparent from the following description, or partly learned from practice of the present disclosure.

According to a first aspect of the present disclosure, there provides a pixel driving circuit including: an organic light emitting diode, a first switching element to a fourth switching element, a storage capacitor and a driving transistor,

wherein

the first switching element is configured to apply a driving voltage and a threshold voltage of the driving transistor to a first terminal of the storage capacitor in response to a threshold compensation signal,

the second switching element is configured to apply the driving voltage to a second terminal of the storage capacitor in response to the threshold compensation signal,

the third switching element is configured to apply a data signal to the second terminal of the storage capacitor in response to a first scan signal,

the driving transistor has a gate connected to the second terminal of the storage capacitor, a source connected to the driving voltage, and a drain connected to the fourth switching element, and

the fourth switching element is configured to apply a driving current output from the drain of the driving transistor to the organic light emitting diode to make it to emit light, in response to a light-emitting control signal.

In an exemplary embodiment of the present disclosure, the first switching element to the fourth switching element are respectively a first switching transistor to a fourth switching transistor.

In an exemplary embodiment of the present disclosure:

the first switching transistor has a gate for receiving the threshold compensation signal, a source connected to the drain of the driving transistor and a drain connected to the first terminal of the storage capacitor,

the second switching transistor has a gate for receiving the threshold compensation signal, a source connected to the driving voltage and a drain connected to the second terminal of the storage capacitor,

the third switching transistor has a gate for receiving the first scan signal, a source for receiving the data signal and a drain connected to the second terminal of the storage capacitor, and

the fourth switching transistor has a gate for receiving the light-emitting control signal, a source connected to the drain of the driving transistor and a drain connected to a first terminal of the organic light emitting diode.

In an exemplary embodiment of the present disclosure, the threshold compensation signal is a second scan signal, the first scan signal is provided by an nth row of scan line, and the second scan signal is provided by an n−1th row of scan line.

In an exemplary embodiment of the present disclosure, the pixel driving circuit further includes:

a fifth switching element, configured to reset the storage capacitor in response to a reset signal.

In an exemplary embodiment of the present disclosure, the pixel driving circuit further includes:

a fifth switching transistor, configured to have a gate for receiving a reset signal, a source connected to an initializing voltage, and a drain connected to the first terminal of the storage capacitor.

In an exemplary embodiment of the present disclosure, the reset signal is a third scan signal, the first scan signal is provided by an nth row of scan line, and the third scan signal is provided by an n−2th row of scan line.

In an exemplary embodiment of the present disclosure, each of the transistors is a P type thin-film transistor, the source of the second switching transistor is connected to a high-level driving voltage, the drain of the fourth switching transistor is connected to an anode of the organic light emitting diode, and a cathode of the organic light emitting diode is connected to a low-level voltage.

In an exemplary embodiment of the present disclosure, each of the transistors is a N type thin-film transistor, the source of the second switching transistor is connected to a low-level driving voltage, the drain of the fourth switching transistor is connected to a cathode of the organic light emitting diode, and an anode of the organic light emitting diode is connected to a high-level voltage.

According to a second aspect of the present disclosure, there provides a driving method for a pixel driving circuit, wherein the pixel driving circuit is the above pixel driving circuit according to the first aspect, and the driving method includes:

turning on the first and second switching elements and turning off the third and fourth switching elements by means of the first scan signal, the light-emitting control signal and the threshold compensation signal, such that the threshold voltage of the driving transistor is written into the storage capacitor;

turning on the third switching element and turning off the first, second and fourth switching elements by means of the first scan signal, the light-emitting control signal and the threshold compensation signal, such that the data signal is written into the storage capacitor; and

turning on the fourth switching element and turning off the first, second and third switching elements by means of the first scan signal, the light-emitting control signal and the threshold compensation signal, such that the driving transistor is turned on by a voltage signal stored in the storage capacitor, so as to drive the organic light emitting diode to emit light.

In an exemplary embodiment of the present disclosure, the pixel driving circuit further includes a fifth switching element configured to reset the storage capacitor in response to a reset signal, and the driving method further includes:

turning on the fifth switching element by means of the reset signal and turning off the first switching element to the fourth switching element by means of the first scan signal, the light-emitting control signal and the threshold compensation signal, such that the fifth switching element resets the storage capacitor by means of an initializing voltage.

According to a third aspect of the present disclosure, there provides a display device including:

a plurality of data lines, respectively configured to provide data signals;

a plurality of scan lines, respectively configured to provide scan signals, wherein the scan signals includes a third scan signal, a second scan signal and a first scan signal provided sequentially; and

a plurality of pixel driving circuits, respectively configured to be electrically connected to the data lines and the scan lines,

wherein each of the pixel driving circuit includes an organic light emitting diode, a first switching element to a fourth switching element, a storage capacitor and a driving transistor, wherein

the first switching element is configured to apply a driving voltage and a threshold voltage of the driving transistor to a first terminal of the storage capacitor in response to a threshold compensation signal,

the second switching element is configured to apply the driving voltage to a second terminal of the storage capacitor in response to the threshold compensation signal,

the third switching element is configured to apply a data signal to the second terminal of the storage capacitor in response to a first scan signal,

the driving transistor has a gate connected to the second terminal of the storage capacitor, a source connected to the driving voltage, and a drain connected to the fourth switching element, and

the fourth switching element is configured to apply a driving current output from the drain of the driving transistor to the organic light emitting diode to make it to emit light, in response to a light-emitting control signal.

In an exemplary embodiment of the present disclosure, the first switching element to the fourth switching element are respectively a first switching transistor to a fourth switching transistor.

In an exemplary embodiment of the present disclosure:

the first switching transistor has a gate for receiving the threshold compensation signal, a source connected to the drain of the driving transistor and a drain connected to the first terminal of the storage capacitor,

the second switching transistor has a gate for receiving the threshold compensation signal, a source connected to the driving voltage and a drain connected to the second terminal of the storage capacitor,

the third switching transistor has a gate for receiving the first scan signal, a source for receiving the data signal and a drain connected to the second terminal of the storage capacitor, and

the fourth switching transistor has a gate for receiving the light-emitting control signal, a source connected to the drain of the driving transistor and a drain connected to a first terminal of the organic light emitting diode.

In an exemplary embodiment of the present disclosure, the threshold compensation signal is a second scan signal, the first scan signal is provided by an nth row of scan line, and the second scan signal is provided by an n−1th row of scan line.

In an exemplary embodiment of the present disclosure, the pixel driving circuit further includes:

a fifth switching element, configured to reset the storage capacitor in response to a reset signal.

In an exemplary embodiment of the present disclosure the pixel driving circuit further includes:

a fifth switching transistor, configured to have a gate for receiving a reset signal, a source connected to an initializing voltage, and a drain connected to the first terminal of the storage capacitor.

In an exemplary embodiment of the present disclosure, the reset signal is a third scan signal, the first scan signal is provided by an nth row of scan line, and the third scan signal is provided by an n−2th row of scan line.

In an exemplary embodiment of the present disclosure, each of the transistors is a P type thin-film transistor, the source of the second switching transistor is connected to a high-level driving voltage, the drain of the fourth switching transistor is connected to an anode of the organic light emitting diode, and a cathode of the organic light emitting diode is connected to a low-level voltage.

In an exemplary embodiment of the present disclosure, each of the transistors is a N type thin-film transistor, the source of the second switching transistor is connected to a low-level driving voltage, the drain of the fourth switching transistor is connected to a cathode of the organic light emitting diode, and an anode of the organic light emitting diode is connected to a high-level voltage.

In the pixel driving circuit provided by the exemplary embodiments of the present disclosure, before the data signal is written into the storage capacitor, the threshold voltage of the driving transistor is stored previously into the storage capacitor, such that the shift of the threshold voltage may be effectively compensated. Accordingly, in a displaying period, uniformity and stability of the driving currents may be guaranteed, so as to achieve an even more even brightness of the OLED display panel.

### BRIEF DESCRIPTION OF THE DRAWINGS

The above and other features and advantages of the present disclosure will become more apparent from the detailed description of the exemplary embodiments with reference to accompanying drawings.

FIG. 1 is a schematic diagram of a pixel driving circuit in the related art;

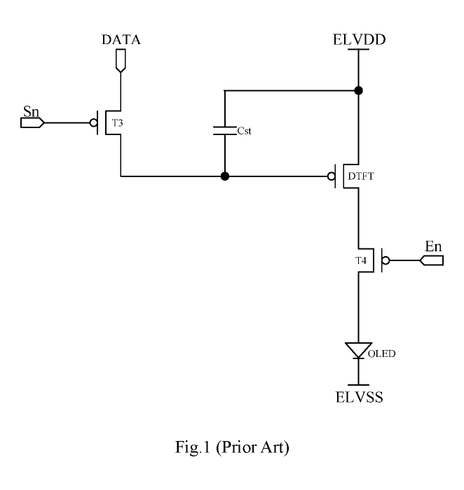

FIG. 2 is a schematic block diagram of a pixel driving circuit in an exemplary embodiment of the present disclosure;

FIG. 3 is a schematic diagram of a pixel driving circuit in an exemplary embodiment of the present disclosure;

FIG. 4 is a schematic timing diagram of the driving of the pixel driving circuit in FIG. 3;

FIG. 5 is an equivalent circuit diagram of the pixel driving circuit in FIG. 3 in a resetting period;

FIG. 6 is an equivalent circuit diagram of the pixel driving circuit in FIG. 3 in a compensating period;

FIG. 7 is an equivalent circuit diagram of the pixel driving circuit in FIG. 3 in a charging period; and

FIG. 8 is an equivalent circuit diagram of the pixel driving circuit in FIG. 3 in a light-emitting period.

The reference numbers are set forth below.
11 first switching element
12 second switching element
13 third switching element
14 fourth switching element
15 fifth switching element
T1 first switching transistor
T2 second switching transistor
T3 third switching transistor
T4 fourth switching transistor
T5 fifth switching transistor
Cst storage capacitor
OLED organic light emitting diode
DTFT driving transistor
Data data signal
Sn first scan signal
Sn-1 second scan signal
Sn-2 third scan signal
En light-emitting control signal
ELVDD driving voltage
ELVSS low-level voltage
Vint initializing voltage

### DETAILED DESCRIPTION

Hereinafter, the exemplary embodiments are fully described with reference to the accompany drawings. However, the exemplary embodiments may be implemented in various forms, and should not be construed as limited to the embodiments set forth herein. Rather, these embodiments are provided to make the present disclosure more complete and thorough, and to fully convey the concept of the exemplary embodiments to those skilled in the art. Same reference numbers refer to same or similar structure throughout the accompany drawings, and detailed description thereof may be omitted.

In addition, the described features, structures and characteristics may be combined to one or more embodiments in any proper manner. In the description below, many specific details are provided for a thorough understanding of the present disclosure. However, it will be appreciated by those skilled in the art that, the technical solutions of the present disclosure may be practiced without one or more of the particular details, or may adopt other method, devices or connections, etc. Under other circumstances, known structures, methods or operations will not be illustrated in detail to avoid obscuring the aspects of the present disclosure.

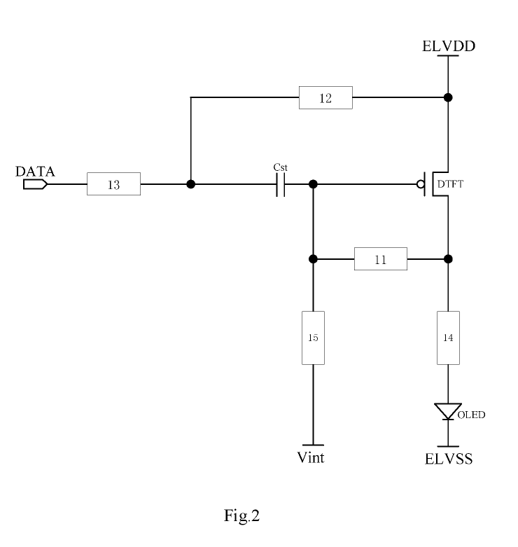

Firstly, a pixel driving circuit is provided in the present exemplary embodiment. As shown in FIG. 2, the pixel driving circuit generally includes an organic light emitting diode OLED, a first switching element 11, a second switching element 12, a third switching element 13, a fourth switching element 14, a storage capacitor Cst and a driving transistor DTFT, etc.

Wherein the first switching element 11 is configured to apply a driving voltage ELVDD and a threshold voltage of the driving transistor DTFT to a first terminal of the storage capacitor Cst in response to a threshold compensation signal. The second switching element 12 is configured to apply the driving voltage ELVDD to a second terminal of the storage capacitor Cst in response to the threshold compensation signal. Accordingly, under a control of the threshold compensation signal, the threshold voltage of the driving transistor DTFT may be written previously into the storage capacitor Cst by means of the first switching element 11 and the second switching element 12. The third switching element 13 receives a data signal Data, and writes the data signal Data into the storage capacitor Cst in response to a first scan signal. The driving transistor DTFT has a gate connected to the second terminal of the storage capacitor Cst, and a source connected to the driving voltage ELVDD. Accordingly, the driving transistor DTFT may be turned on or turned off as driven by a voltage signal stored in the storage capacitor Cst. The fourth switching element 14 has a first terminal connected to a drain of the driving transistor DTFT, and a second terminal connected to a first terminal of the organic light emitting diode OLED, so as to apply a driving current output from the drain of the driving transistor DTFT to the organic light emitting diode OLED to make it to emit light, in response to a light-emitting control signal.

As shown in FIG. 2, in the exemplary embodiment, the pixel driving circuit may also include a fifth switching element 15. The fifth switching element 15 has a first terminal connected to an initializing voltage Vint, and a second terminal connected to the first terminal of the storage capacitor Cst, and is configured to reset the storage capacitor Cst by means of the initializing voltage Vint in response to a reset signal.

A driving method for the pixel driving circuit is briefly described below. The method may include the following periods.

In a reset period, the fifth switching element 15 is turned on and the first switching element to the fourth switching element are turned off by means of the first scan signal, the light-emitting control signal, the threshold compensation signal and the reset signal, such that the initializing voltage Vint is written into the storage capacitor Cst via the fifth switching element 15 to reset the storage capacitor Cst, so as to eliminate an influence caused by a previous frame of residual voltage signal.

In a compensating period, the first and second switching elements are turned on and the third switching element to the fifth switching element are turned off by means of the first scan signal, the light-emitting control signal, the threshold compensation signal and the reset signal, such that the driving voltage ELVDD and the threshold voltage of the driving transistor DTFT are applied to the first terminal of the storage capacitor Cst and the driving voltage ELVDD is applied to the second terminal of the storage capacitor Cst, such that the threshold voltage of the driving transistor DTFT is written previously into the storage capacitor Cst.

In a charging period, the third switching element 13 is turned on and the first, second, fourth and fifth switching elements are turned off by means of the first scan signal, the light-emitting control signal, the threshold compensation signal and the reset signal, such that the data signal Data is written into the storage capacitor Cst.

In a displaying period, the fourth switching element 14 is turned on an the first, second, third and fifth switching elements are turned off by means of the first scan signal, the light-emitting control signal, the threshold compensation signal and the reset signal, such that the driving transistor DTFT is turned on by the voltage signal stored in the storage capacitor Cst, so as to drive the organic light emitting diode OLED to emit light.

In the above pixel driving circuit, the storage capacitor Cst is reset by the fifth switching element 15 firstly, so as to eliminate an influence caused by a previous frame of residual voltage signal. Then the threshold voltage of the driving transistor DTFT is stored previously to the storage capacitor Cst by the first and second switching elements. Thus the shift of the threshold voltage may be effectively compensated. Accordingly, in a displaying period, uniformity and stability of the driving currents may be guaranteed, so as to achieve an even more even brightness of the OLED display panel.

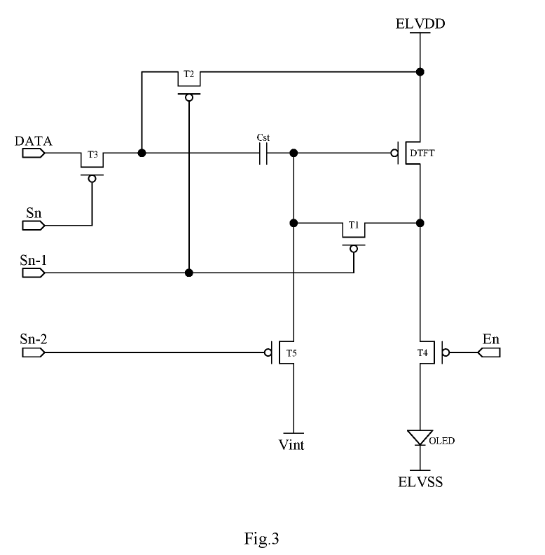

FIG. 3 shows is a specific implementation of the above pixel driving circuit, and the above first switching element 11 to the fourth switching element 14 may be respectively a first switching transistor T1 to a fourth switching transistor T4. In addition, the fifth switching element 15 may be a fifth switching transistor T5. The first switching transistor T1 has a gate for receiving the threshold compensation signal, a source connected to the drain of the driving transistor DTFT and a drain connected to the first terminal of the storage capacitor Cst. The second switching transistor T2 has a gate for receiving the threshold compensation signal, a source connected to the driving voltage ELVDD, a drain connected to the second terminal of the storage capacitor Cst. The first and second switching transistors T1 and T2 may be turned on or off under a control of the threshold compensation signal. The third switching transistor T3 has a gate connected to a first scan line, a source for receiving the data signal Data, and a drain connected to the second terminal of the storage capacitor Cst. The third switching transistor T3 may be turned on or off under a control of the first scan signal Sn output from the first scan line. The fourth switching transistor T4 has a gate for receiving a light-emitting control signal En, a source connected to the drain of the driving transistor DTFT, and a drain connected to the first terminal of the organic light emitting diode OLED. The fourth switching transistor T4 may be turned on or off under a control of the light-emitting control signal En. The fifth switching transistor T5 has a gate for receiving the reset signal, a source connected to an initializing voltage Vint, and a drain connected to the first terminal of the storage capacitor Cst. The fifth switching transistor T5 may be turned on or off under a control of the reset signal.

In an exemplary embodiment of the present disclosure, the above threshold compensation signal may be a second scan signal Sn-1 which is provided by a second scan line that is a previous row of scan line of the first scan line. For example, the first scan line is an n^{th} row of scan line, then the threshold compensation signal may be provided by an n−1^{th} row of scan line. The above reset signal may be a third scan signal which is provided by a third scan line that is a row of scan line two rows previous to the first scan line. For example, the first scan line is an n^{th} row of scan line, then the reset signal may be provided by an n−2^{th} row of scan line. Thereby, the total number of control signals and control lines may be reduced.

In the present embodiment, another advantage of the pixel driving circuit lies in that, each of the transistors is of a same type of channel, that is, each of the transistors is a P type thin-film transistor. Adopting entirely P type thin-film transistors has the following advantages. For example, noise suppression ability is strong; a P type thin-film transistor is turned on at a low level which may be implemented more easily in charging management; an N type thin-film transistor may be easily subject to an influence of ground bounce, while a P type thin-film transistor may be only subject to an influence of IR (Internal Resistance) drop of the driving voltage ELVDD line, which may be eliminated more easily; a P type thin-film transistor has a simple manufacturing process and a relatively low price; and a P type thin-film transistor has a higher stability, and so on. Accordingly, adopting entirely P type thin-film transistors may not only reduce complexity of manufacturing process and production cost, but also may improve product quality. As shown in FIG. 3, when each of the transistors is a P type thin-film transistor, the sources of the driving transistor DTFT and the second switching transistor T2 are connected to a high-level driving voltage ELVDD, the drain of the fourth switching transistor T4 is connected to an anode of the organic light emitting diode OLED, and a cathode of the organic light emitting diode OLED is connected to a low-level voltage ELVSS.

However, it may be easily anticipated by those skilled in the art that the pixel driving circuit provided by the present disclosure may be simply modified to a circuit of entire N type thin-film transistors. In this case, the structure of the circuit is different from the circuit composed of P type thin-film transistors, and the difference lies in that, when each of the transistors is a N type thin-film transistor, the sources of the driving transistor and the second switching transistor are connected to a low-level driving voltage, the drain of the fourth switching transistor is connected to the cathode of the organic light emitting diode, and the anode of the organic light emitting diode is connected to a high-level voltage. Furthermore, the pixel driving circuit provided by the present disclosure may be easily modified to be a CMOS (Complementary Metal Oxide Semiconductor) circuit, and not be limited by the pixel driving circuit provided by the embodiments of the present disclosure, the details of which are not repeated herein.

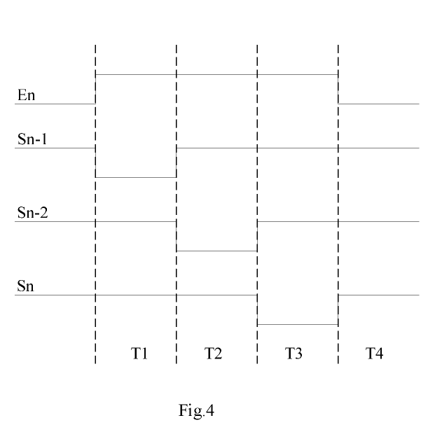

Hereinafter, the driving method for the pixel driving circuit shown in FIG. 3 will be described with reference to the driving timing diagram of FIG. 4. As shown in FIG. 4, the driving method generally includes a reset period T1, a compensating period T2, a charging period T3 and a displaying period T4.

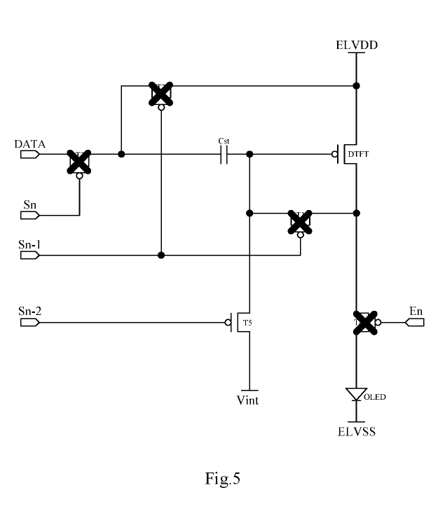

As shown in FIGS. 4 and 5, in the reset period T1, each of the first scan signal Sn, the second scan signal Sn-1 and the light-emitting control signal En is a high level, the first switching transistor T1, the second switching transistor T2, the third switching transistor T3 and the switching transistor T4 are turned off, the third scan signal Sn-2 is a low level, and the fifth switching transistor T5 is turned on, such that the initializing voltage Vint is applied to the first terminal of the storage capacitor Cst via the fifth switching transistor T5, such that the voltage of the gate of the driving transistor DTFT equals to Vint, so as to eliminate an influence caused by a previous frame of residual voltage signal.

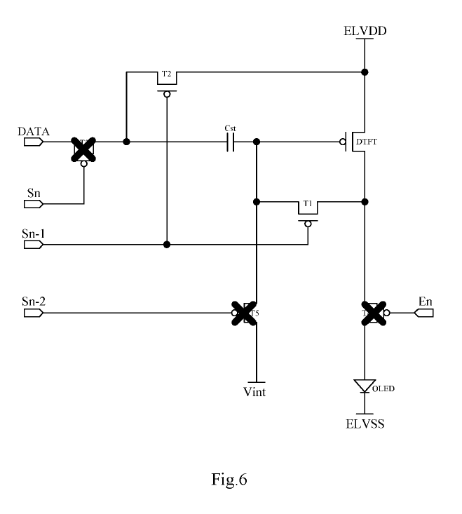

As shown in FIGS. 4 and 6, in the compensating period T2, each of the first scan signal Sn, the third scan signal Sn-2 and the light-emitting control signal En is a high level, the third switching transistor T3, the fourth switching transistor T4 and the fifth switching transistor T5 are turned off, the second scan signal Sn-1 is a low level, and the first switching transistor T1 and the second switching transistor T2 are turned on, such that the driving voltage ELVDD and the threshold voltage of the driving transistor DTFT are applied to the first terminal of the storage capacitor Cst via the first switching transistor T1 and the driving voltage ELVDD is applied to the second terminal of the storage capacitor Cst via the second switching transistor T2, such that the threshold voltage of the driving transistor DTFT is written previously into the storage capacitor Cst.

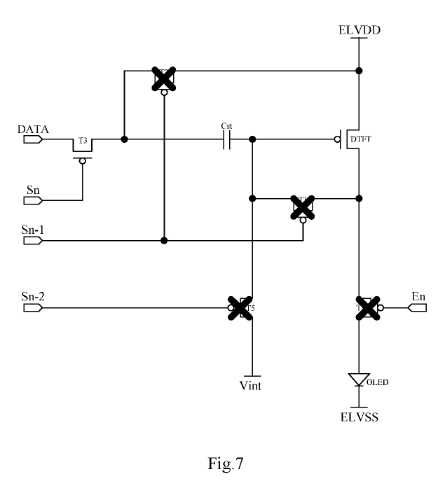

As shown in FIGS. 4 and 7, in the charging period T3, each of the second scan signal Sn-1, the third scan signal Sn-2 and the light-emitting control signal En is a high level, the first switching transistor T1, the second switching transistor T2, the fourth switching transistor T4 and the fifth switching transistor T5 are turned off, the first scan signal Sn is a low level, and the third switching transistor T3 is turned on, such that the data signal Data is written into the storage capacitor Cst via the third switching transistor T3. The voltage of the first terminal of the storage capacitor Cst is the gate voltage V_{g} of the driving transistor DTFT, that is:

V_{g}=ELVDD−Vth−(ELVDD−Vdata)=Vdata−Vth.

Wherein Vdata is a level of the data signal Data, and Vth is the threshold voltage of the driving transistor DTFT.

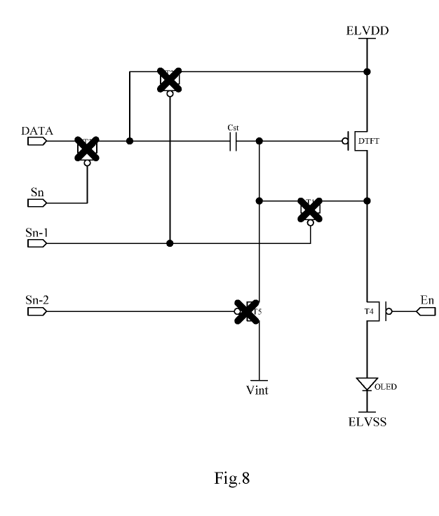

As shown in FIGS. 4 and 8, in the displaying period T4, each of the first scan signal Sn, the second scan signal Sn-1 and the third scan signal Sn-2 is a high level, the first switching transistor T1, the second switching transistor T2, the third switching transistor T3 and the fifth switching transistor T5 are turned off, the light-emitting control signal En is a low level, the fourth switching transistor T4 is turned on, such that the voltage of the first terminal of the driving transistor DTFT, i.e., the source voltage Vs of the driving transistor DTFT is:

Vₛ=ELVDD.

Then the gate-source voltage Vgs thereof is:

V_{gs}=Vₛ−V_{g}=ELVDD−(Vdata−Vth).

At this time, the driving transistor DTFT is in a saturation state, to provide a stable driving current to the organic light emitting diode OLED, and the driving current to the organic light emitting diode OLED is:

$$\begin{matrix}{I}_{oled} = \frac{1}{2} {μ}_{n} \cdot {C}_{OX} \cdot \frac{W}{L} \cdot {( {V}_{gs} - Vth )}^{2} \\ = \frac{1}{2} {μ}_{n} \cdot {C}_{OX} \cdot \frac{W}{L} \cdot {( ELVDD - ( Vdata - Vth ) - Vth )}^{2} \\ = \frac{1}{2} {μ}_{n} \cdot {C}_{OX} \cdot \frac{W}{L} \cdot {( ELVDD - Vdata )}^{2} .\end{matrix}$$

Wherein μₙ·C_{OX}·W/L is a constant related to manufacturing process and design of the driving. Eventually, the driving current drives the organic light emitting diode OLED to emit light via the fourth switching transistor T4.

Accordingly, in the exemplary embodiments, the driving current gets rid of the influence of the threshold voltage of the driving transistor DTFT, such that the shift of the threshold voltage of the driving transistor DTFT may not affect the drain current thereof, that is, the driving current Ioled for the organic light emitting diode OLED. Thus, in the exemplary embodiments, since the shift in threshold voltage may be effectively compensated, uniformity and stability of the driving currents may be guaranteed, so as to achieve an even more even brightness of the OLED display panel.

Further, an exemplary embodiment also provides a display device. The display device includes: a plurality of data lines, respectively configured to provide data signals; a plurality of scan lines, respectively configured to provide scan signals; and a plurality of pixel driving circuits, configured to be electrically connected to the data lines and the scan lines. The pixel driving circuit is any one pixel driving circuit of the above exemplary embodiments. Since the pixel driving circuit may compensate the shift of the threshold voltage of the driving transistor, the organic light emitting diode may display stably, such that the uniformity of the brightness of the displaying device may be improved, thus the display quality may be significantly improved.

Although the present disclosure has been described with reference to the above embodiments, the embodiments are merely examples for implementing the present disclosure. It should be noted that the disclosed embodiments are not intended to limit the scope of the present disclosure. Rather, alteration and modification without departing from the spirit and scope of the present disclosure all belong to the protective scope of the present disclosure.

What is claimed is:

1. A pixel driving circuit, comprising:
an organic light emitting diode, a first switching element to a fourth switching element, a storage capacitor and a driving transistor,
wherein
the first switching element is configured to apply a driving voltage and a threshold voltage of the driving transistor to a first terminal of the storage capacitor in response to a threshold compensation signal,
the second switching element is configured to apply the driving voltage to a second terminal of the storage capacitor in response to the threshold compensation signal,
the third switching element is configured to apply a data signal to the second terminal of the storage capacitor in response to a first scan signal,
the driving transistor has a gate connected to the second terminal of the storage capacitor, a source connected to the driving voltage, and a drain connected to the fourth switching element, and
the fourth switching element is configured to apply a driving current output from the drain of the driving transistor to the organic light emitting diode to make it to emit light, in response to a light-emitting control signal.

2. The pixel driving circuit according to claim 1, wherein
the first switching element to the fourth switching element are respectively a first switching transistor to a fourth switching transistor.

3. The pixel driving circuit according to claim 2, wherein
the first switching transistor has a gate for receiving the threshold compensation signal, a source connected to the drain of the driving transistor and a drain connected to the first terminal of the storage capacitor,
the second switching transistor has a gate for receiving the threshold compensation signal, a source connected to the driving voltage and a drain connected to the second terminal of the storage capacitor,
the third switching transistor has a gate for receiving the first scan signal, a source for receiving the data signal and a drain connected to the second terminal of the storage capacitor, and
the fourth switching transistor has a gate for receiving the light-emitting control signal, a source connected to the drain of the driving transistor and a drain connected to a first terminal of the organic light emitting diode.

4. The pixel driving circuit according to claim 1, wherein the threshold compensation signal is a second scan signal, the first scan signal is provided by an n^{th} row of scan line, and the second scan signal is provided by an n−1^{th} row of scan line.

5. The pixel driving circuit according to claim 1, wherein the pixel driving circuit further comprises:
a fifth switching element, configured to reset the storage capacitor in response to a reset signal.

6. The pixel driving circuit according to claim 3, wherein the pixel driving circuit further comprises:
a fifth switching transistor, configured to have a gate for receiving a reset signal, a source connected to an initializing voltage, and a drain connected to the first terminal of the storage capacitor.

7. The pixel driving circuit according to claim 5, wherein the reset signal is a third scan signal, the first scan signal is provided by an n^{th} row of scan line, and the third scan signal is provided by an n−2^{th} row of scan line.

8. The pixel driving circuit according to claim 5, wherein each of the transistors is a P type thin-film transistor, the source of the second switching transistor is connected to a high-level driving voltage, the drain of the fourth switching transistor is connected to an anode of the organic light emitting diode, and a cathode of the organic light emitting diode is connected to a low-level voltage.

9. The pixel driving circuit according to claim 5, wherein each of the transistors is a N type thin-film transistor, the source of the second switching transistor is connected to a low-level driving voltage, the drain of the fourth switching transistor is connected to a cathode of the organic light emitting diode, and an anode of the organic light emitting diode is connected to a high-level voltage.

10. A driving method for a pixel driving circuit, wherein the pixel driving circuit is the above pixel driving circuit according to claim 1, and the driving method comprises:
turning on the first and second switching elements and turning off the third and fourth switching elements by means of the first scan signal, the light-emitting control signal and the threshold compensation signal, such that the threshold voltage of the driving transistor is written into the storage capacitor;
turning on the third switching element and turning off the first, second and fourth switching elements by means of the first scan signal, the light-emitting control signal and the threshold compensation signal, such that the data signal is written into the storage capacitor; and
turning on the fourth switching element and turning off the first, second and third switching elements by means of the first scan signal, the light-emitting control signal and the threshold compensation signal, such that the driving transistor is turned on by a voltage signal stored in the storage capacitor, so as to drive the organic light emitting diode to emit light.

11. The driving method for a pixel driving circuit according to claim 10, wherein the pixel driving circuit further comprises a fifth switching element configured to reset the storage capacitor in response to a reset signal, and the driving method further comprises:
turning on the fifth switching element by means of the reset signal and turning off the first switching element to the fourth switching element by means of the first scan signal, the light-emitting control signal and the threshold compensation signal, such that the fifth switching element resets the storage capacitor by means of an initializing voltage.

12. A display device, comprising:
a plurality of data lines, respectively configured to provide data signals;
a plurality of scan lines, respectively configured to provide scan signals, wherein the scan signals comprises a third scan signal, a second scan signal and a first scan signal provided sequentially; and
a plurality of pixel driving circuits, respectively configured to be electrically connected to the data lines and the scan lines,
wherein each of the pixel driving circuit comprises an organic light emitting diode, a first switching element to a fourth switching element, a storage capacitor and a driving transistor, wherein
the first switching element is configured to apply a driving voltage and a threshold voltage of the driving transistor to a first terminal of the storage capacitor in response to a threshold compensation signal,
the second switching element is configured to apply the driving voltage to a second terminal of the storage capacitor in response to the threshold compensation signal,
the third switching element is configured to apply a data signal to the second terminal of the storage capacitor in response to a first scan signal,
the driving transistor has a gate connected to the second terminal of the storage capacitor, a source connected to the driving voltage, and a drain connected to the fourth switching element, and
the fourth switching element is configured to apply a driving current output from the drain of the driving transistor to the organic light emitting diode to make it to emit light, in response to a light-emitting control signal.

13. The display device according to claim 12, wherein
the first switching element to the fourth switching element are respectively a first switching transistor to a fourth switching transistor.

14. The display device according to claim 13, wherein
the first switching transistor has a gate for receiving the threshold compensation signal, a source connected to the drain of the driving transistor and a drain connected to the first terminal of the storage capacitor,
the second switching transistor has a gate for receiving the threshold compensation signal, a source connected to the driving voltage and a drain connected to the second terminal of the storage capacitor,
the third switching transistor has a gate for receiving the first scan signal, a source for receiving the data signal and a drain connected to the second terminal of the storage capacitor, and
the fourth switching transistor has a gate for receiving the light-emitting control signal, a source connected to the drain of the driving transistor and a drain connected to a first terminal of the organic light emitting diode.

15. The display device according to claim 12, wherein the threshold compensation signal is a second scan signal, the first scan signal is provided by an n^{th} row of scan line, and the second scan signal is provided by an n−1^{th} row of scan line.

16. The display device according to claim 12, wherein the pixel driving circuit further comprises:
a fifth switching element, configured to reset the storage capacitor in response to a reset signal.

17. The display device according to claim 14, wherein the pixel driving circuit further comprises:
a fifth switching transistor, configured to have a gate for receiving a reset signal, a source connected to an initializing voltage, and a drain connected to the first terminal of the storage capacitor.

18. The display device according to claim 16, wherein the reset signal is a third scan signal, the first scan signal is provided by an n^{th} row of scan line, and the third scan signal is provided by an n−2^{th} row of scan line.

19. The display device according to claim 16, wherein each of the transistors is a P type thin-film transistor, the source of the second switching transistor is connected to a high-level driving voltage, the drain of the fourth switching transistor is connected to an anode of the organic light emitting diode, and a cathode of the organic light emitting diode is connected to a low-level voltage.

20. The display device according to claim 16, wherein each of the transistors is a N type thin-film transistor, the source of the second switching transistor is connected to a low-level driving voltage, the drain of the fourth switching transistor is connected to a cathode of the organic light emitting diode, and an anode of the organic light emitting diode is connected to a high-level voltage.
